(19) United States
(12) Patent Application Publication
(10) Pub. No.: US 2015/0019451 A1
(43) Pub. Date: Jan. 15, 2015

(54) DECISION BASIS FOR BENEFITS PROGRAM

(71) Applicants: Mirko Schnack, Heidelberg (DE); Claus Steimer, Weingarten (DE); Miroslav Cina, Hanhofen (DE); Ulrich Zagler, Nussloch (DE)

(72) Inventors: Mirko Schnack, Heidelberg (DE); Claus Steimer, Weingarten (DE); Miroslav Cina, Hanhofen (DE); Ulrich Zagler, Nussloch (DE)

(73) Assignee: SAP AG, Walldorf (DE)

(21) Appl. No.: 13/938,083

(22) Filed: Jul. 9, 2013

(51) Int. Cl. G06Q 10/10

(52) U.S. Cl. CPC G06Q 10/1057
USPC 705/322

(57) ABSTRACT

A computer implemented method including populating a data structure, stored on a computer readable storage device, with data for use in determining eligibility for benefits from a benefits program, performing a verification check on the data using evidence related to the data, making a decision regarding eligibility for benefits based on the verified data and rules for the benefits program, and storing the data utilized in the decision, including the evidence used in the verification check.

### BACKGROUND

Making decisions regarding an applicant's eligibility and entitlement for social benefits is a core part of all social benefits programs. The decisions are usually supported by a set of program rules regarding eligibility and entitlement. A case worker usually makes the decision after collecting data and applying the rules. The data is often received from an application form filled out by an applicant. Some of the data may need investigation by the case worker, such as performing an assessment at the applicant's home, calling an employer to obtain additional data about a job or salary, or requesting a doctor's statement about a type and severity of an illness.

### SUMMARY

A computer implemented method including populating a data structure, stored on a computer readable storage device, with data for use in determining eligibility for benefits from a benefits program, wherein the data structure comprises a hierarchical structure of entity types including top entity types and child entity types, wherein each child entity instances contain data related to a parent top entity type, performing a verification check on a entity instance data using evidence related to the entity instance data, making a decision regarding eligibility for benefits based on the verified data in the data structure and rules for the benefits program, and storing the data from the data structure utilized in the decision, including the evidence used in the verification check.

A computer readable storage device having instructions for causing a computer to execute a method, the method comprising, populating a data structure, stored on a computer readable storage device, with data for use in determining eligibility for benefits from a benefits program, performing a verification check on the data using evidence related to the data, making a decision regarding eligibility for benefits based on the verified data and rules for the benefits program, and storing the data utilized in the decision, including the evidence used in the verification check.

A data structure stored on a computer readable storage device, the data structure comprising, data for use in determining applicant eligibility for benefits from a benefits program, wherein the data is arranged in a hierarchical structure of entity types including top entity types and child entity types, wherein each child entity instance contains data related to a parent top entity type, and verification data usable in verifying the data, wherein the data in the data structure comprises all data relied upon to determine eligibility and benefits under the benefits program.

### BRIEF DESCRIPTION OF THE DRAWINGS

FIG. 1 is a block diagram illustrating data management in a benefit decision application according to an example embodiment.

FIG. 2 is a block diagram illustrating data structures utilized to store data for use in computer driven benefits determinations according to an example embodiment.

FIG. 3 is a block flow diagram illustrating the flow of decisions and corresponding data processing for a computer executed benefits determination according to an example embodiment.

FIG. 4 is a block flow diagram illustrating a verification process according to an example embodiment.

FIG. 5 is a representation of a user interface for interacting with consistency checks according to an example embodiment.

FIG. 6 is a representation of a user interface for interacting with verification checks according to an example embodiment.

FIG. 7 is a user interface allowing customization of verification checks according to an example embodiment.

FIG. 8 is a user interface illustrating a decision basis according to an example embodiment.

FIG. 9 is a user interface showing a view of a case currently being worked on according to an example embodiment.

FIG. 10 is a block schematic diagram of a computer system to implement one or more methods and systems according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

A system and method are used to make decisions regarding benefits under a benefits program. A decision basis data structure is used to store the data relied upon to make the decision. The data saved in the decision basis data structure may be relied upon to look back in time to see what the data was when the decision to grant or deny particular benefits under a benefits program was made. This can be quite useful, as data may change over time. Salary information, dependent information, marital status, and other information may change, making it difficult to recreate the information used to make a decision or to calculate an amount of a benefit. In various embodiments, a verification check on the data may be made using evidence related to the data. A decision regarding eligibility for benefits may be based on the verified data and rules for the benefits program. The decision basis may include the data utilized in the decision, as well as the evidence used in the verification check.

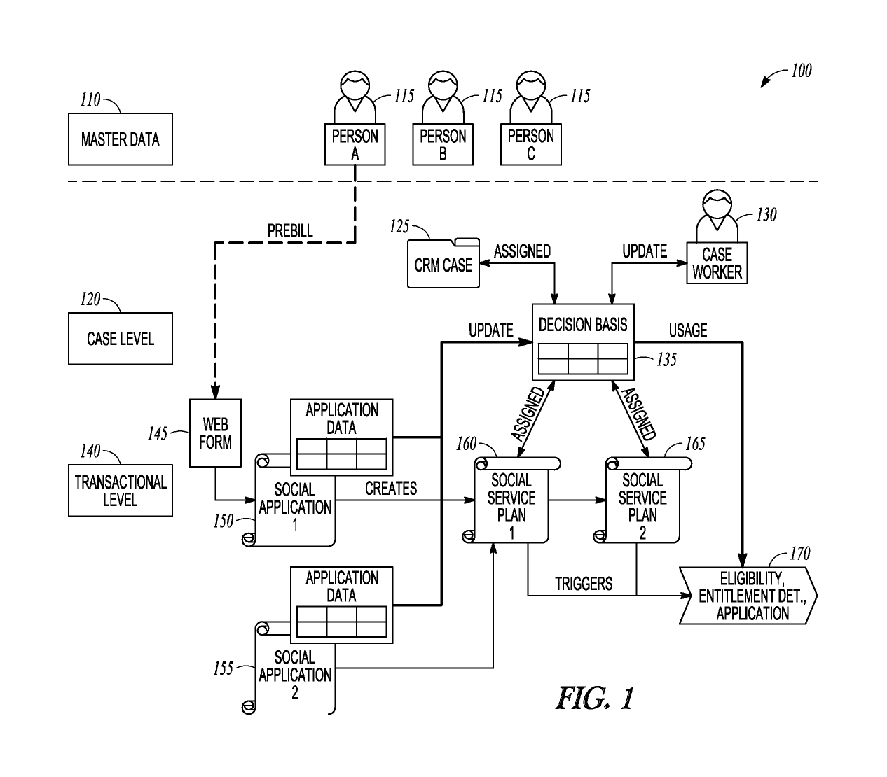

FIG. 1 is a block diagram illustrating data management in a benefit decision system 100 according to an example embodiment. In one embodiment, a master data level 110 corresponds to data stored for multiple persons 115. The master data may include data that is generic to persons, such as age, address, and other common information related to multiple people. A case level layer 120 corresponds to data related to particular cases as indicated at 125, a case worker 130, and a decision basis 135, which is a container that holds all the information relied upon by the system and case worker in making a decision on a benefits application. In one embodiment, the decision basis 135 is a separate object, and is not directly part of a case or part of a social services plan being administered via the system. The decision basis 135 may be unique for all decisions within one decision flow. Further decisions within the one decision flow may use the same decision basis.

At a transaction level 140 web forms 145 are received in one embodiment corresponding to applications for benefits indicated at 150, 155, each having corresponding application costs. The applications contain information that further populates the decision basis 135, and is also evaluated pursuant to a corresponding service plan, two of which are indicated at 160, 165. Different people may have different benefits plans, each with its own corresponding set of rules. Information is also checked for eligibility and entitlement at 170 in accordance with the rules of the plan under which an application is to be processed.

The data which shall be used as the basis for the rules evaluation and finally as the basis for any final decision on eligibility or entitlements can originate from many different sources. Very often, this data is received via the application form for a social benefit or program. The data might partially be received from external sources like the tax authority (for income data), the citizen register (for address and family relations information), or others. Some data might need some ‘investigation’ activities by the caseworkers 130 or other involved parties, e.g. performing an assessment at the client's home, calling the employer to achieve additional data about the client's job, or requesting a doctor's statement about the type and severeness of illness of a client.

Sometimes, the caseworker needs to overrule/overwrite some data which was received from other sources in order to get the right interpretation (or the intended result) for this particular case situation. For example, the ‘official’ size of the client's flat like officially received from a ‘flat register’ or other source of information such as a listing service, might need to be adjusted by the caseworker for the use within this specific case.

Data management in one embodiment focuses on a more centralized data concept which tries to avoid duplicative data and therefore minimizes fraud. In these concepts, the data is expected to be re-used across several business areas, programs and cases, depending on the type of data.

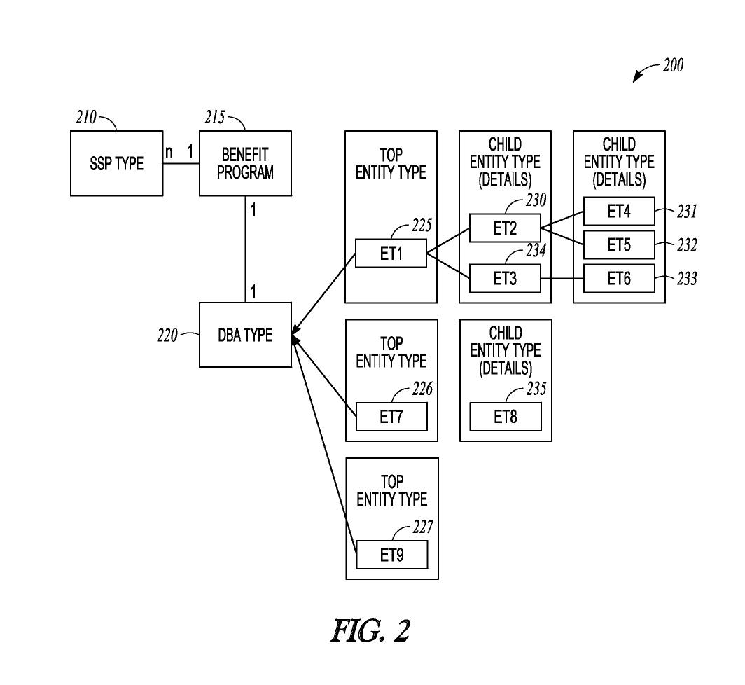

FIG. 2 is a block diagram illustrating data structures 200 utilized to store data for use in computer driven benefits determinations. An entity type defines the data structure of the smallest data unit that belongs together from business point of view. Multiple types of entities are illustrated at 200. A top level entity type is assigned to a decision basis for a social services plan (SSP) 210. There can be many different types of social services plans, and in various embodiments, there may be different types of benefits plans, such as insurance plans, long term care plans, social security, worker's compensation, disability, etc. The types of plans may extend beyond those administered by government entities, and may include benefits plans operated by private industry.

Entity types can be arranged in hierarchical structures. At 215, a benefit program is shown having a decision basis (DBA) type 220. Multiple top entity types 225, 226, 227 are illustrated as coupled to respective child entity types 230, 231, 232, 233, 234, 235. The child entity types contain detail information with respect to the parent entity type. An example could be that salary information is a detail of a working relation. An instance of an entity type is called an entity. An example could be the concrete working relation to employer X. The root entity (type) of a hierarchy is also called a top entity (type).

Each parent entity can have zero to n child entities of the same child entity type. An example could be that one working relation could have zero to many salary information assigned. The data structure of a decision basis type is defined by assigning a set of those entity type hierarchies.

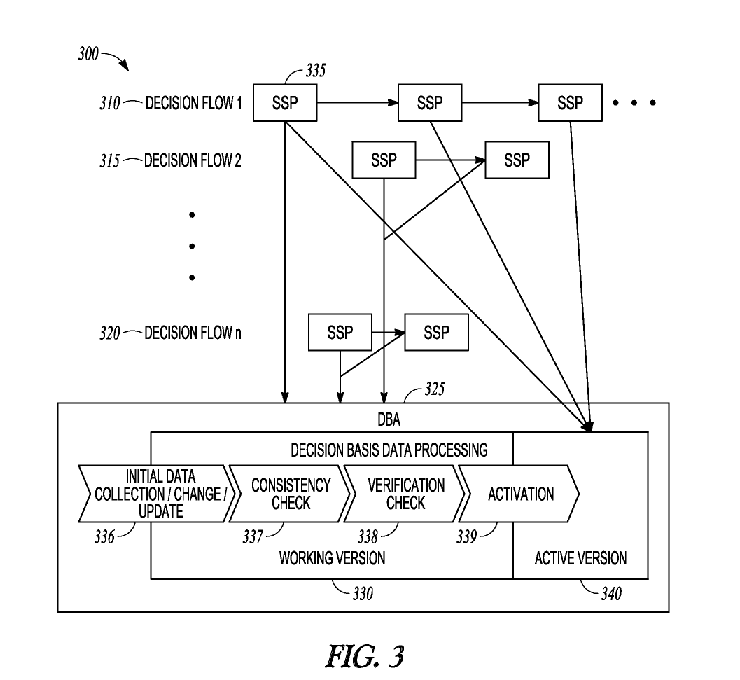

FIG. 3 is a block flow diagram illustrating the flow of decisions and corresponding data processing for a computer executed benefits determination at 300. Multiple decision flows 310, 315, 320 are shown. The first decision flow 310 is mapped to a decision basis data processing flow indicated at 325. A decision basis working version 330 is initially created via a Social Service Plan 335 (after case assignment). In one embodiment, a search is executed to find a decision basis if one is already existing. If no such decision basis is found, a new one is created. There is just one decision basis per decision flow in one embodiment, and one decision basis type per benefit program. In further embodiments, multiple decision flows may share the same decision basis. In some cases, a decision basis may be copied from a different decision flow and then modified and saved with a new decision flow.

In addition to the working version 330, there is an active version 340 of the decision basis. Just active data may be used by the SSP processes 335. The working version of the DBA 325 is used to set up rules for data collection, changes, and updates, completeness checking to ensure there is sufficient data for a benefits decision and calculation, eligibility determination, entitlement determination, entitlement calculation. After the creation of a decision basis it can be initially filled. Entering of new data at 336 or changing existing data is done on the working version 330 of the decision basis. New or changed data is first checked at 337 to be consistent by rules of the program. Entities could be relevant for a verification at 338 and if verified, an activation step 339 results in activation of the active version 340. If no verification is needed, activation is separated from verification.

In one embodiment, all SSPs of a flow share the same DBA 325, the one the first SSP 335 was assigned to. The first SSP 335 of all flows that share the same DBA creates the DBA and triggers the initial data collection. The SSP process steps eligibility determination, entitlement determination and entitlement calculation just use active data in their rules. New DBA data is entered via the working version 330 and passes the DBA processing to reach the active version 340.

In one embodiment, consistency of the data is a precondition for verification. Verification is a precondition for activation. Verification may be automatically executed top down. If a parent node is not verified, a child node of that parent is not verified. Similarly, if a parent node is not activated, a child note of that parent is also not activated.

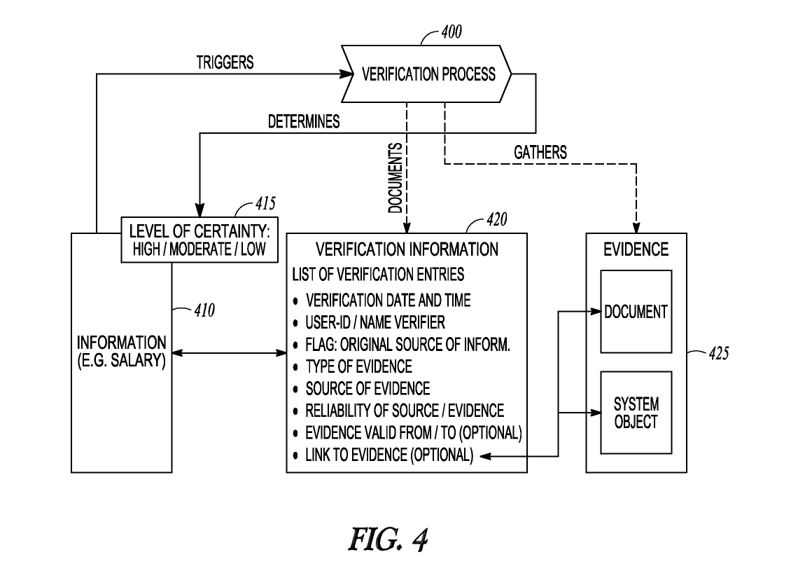

FIG. 4 is a block flow diagram illustrating a verification process 400. In one example embodiment, receipt of information, such as salary information at 410 triggers the verification process 400. The verification process 400 determines a level of certainty at 415. The level of certainty for the information in one embodiment is set at various levels depending on the rules of the program being administered, such as high, moderate, or low. The level of certainty is the likelihood that the information assessed or verified is correct. The certainty level is assigned as a result of the verification process based on the nature of the overall evidence available to assess the truth of the information.

Verification information is generated at 420 and in various embodiments, may include a list of verification entries, such as verification date and time, user ID, name of vender, verification text, a flag indicating a source of the information is original, reliability of the source or evidence, evidence valid from—to, and a link. Some of the verification information is optional, such as the validity period of the information and the link.

The link to evidence is indicated as coupled to an evidence source 425, such as a document or system object for example. The verification process 400 utilizes the verification information 420, and may also gather the evidence 425, in order to apply verification rules which may be derived from the program being administered. Two or more items may be compared in order to determine the truth or correctness of a piece of information provided in the application for benefits in one embodiment.

In one embodiment, evidence 425 in the broadest sense includes everything that is used to determine or demonstrate the truth of an assertion. Giving or procuring evidence is the process of using those things that are either presumed to be true, or were themselves proven via evidence to demonstrate an assertion's truth.

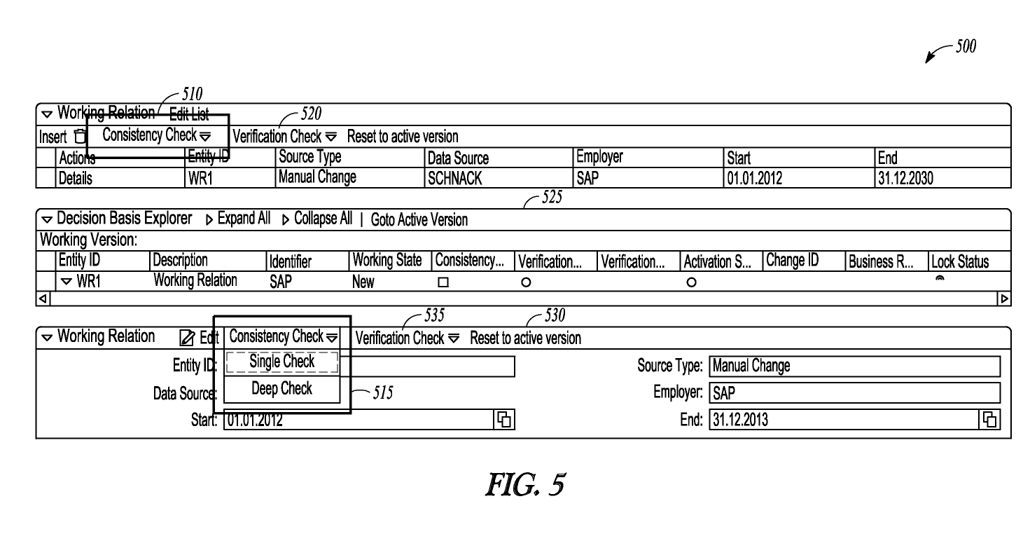

FIG. 5 is a representation of a user interface 500 for interacting with consistency checks 510. In one embodiment, a consistency check is a customer owned rule that can be set up per entity type (e.g. start date of the working relation is before the end date). The consistency check can either be triggered for a specific entity or for an entity and all sub-entities (deep) as indicated at 515.

User interface 500 provides a user interface for working with decision base processing logic. A working relation screen provides the ability to select consistency checking 510 and verification checking at 520. Fields are included for showing a source type, data source, employer, start date, and end dates. In a decision basis explorer 525 portion of interface 500, fields are provided for entity ID, description, identifier, working state, consistency verification, activation, change ID, business relationship, lock status, etc. Further detail regarding the working relation is illustrated at 530, including the various levels of consistency checking desired at 515 and a verification check menu 535.

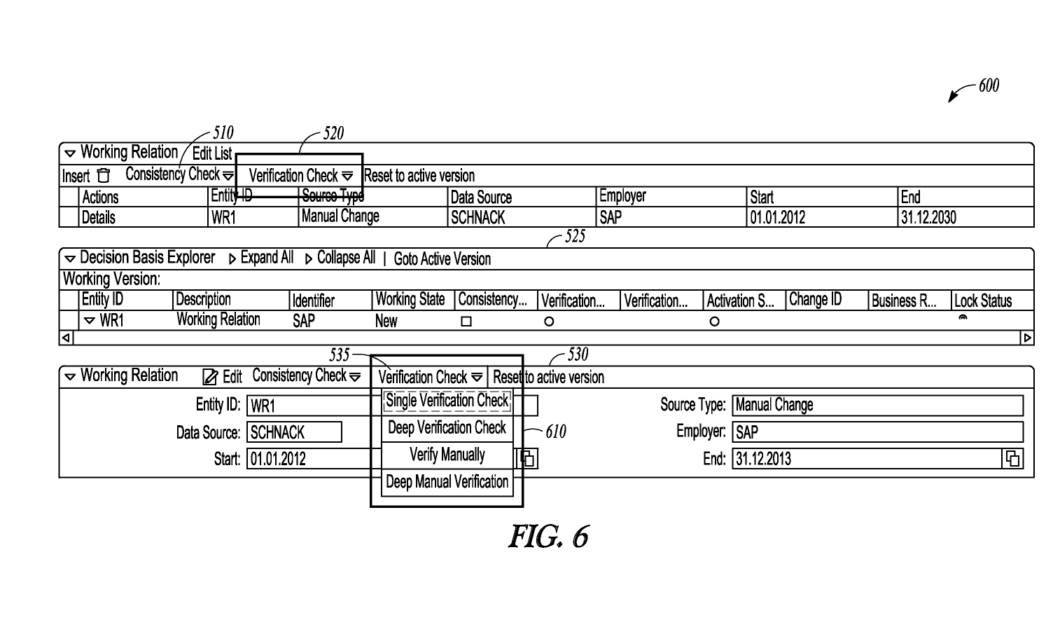

FIG. 6 is a representation of a user interface 600 for interacting with verification checks 520. The numbering in FIG. 6 is consistent with that of FIG. 5 where appropriate. The verification check 535 pull down menu has been selected in FIG. 6 and is represented at 610. Options provided include a single verification check, deep verification check, verify manually, and deep manual verification in one embodiment. Further options may be provided in further embodiments.

Some entities of a decision basis might be verified first before they should be used in a decision making process (SSP). For example, if the salary information would lead to a high payment, the salary information needs to be verified first to check if it is true. Sometimes it is possible to do this check automatically, such as by checking salary against a tax register. Sometimes the check is done manually utilizing caseworker judgment. The automatic and manual versification could also be triggered deep, such as for the selected entity and all entities below.

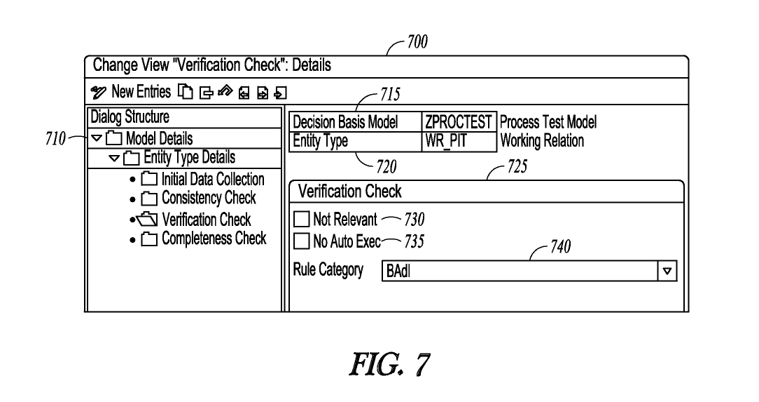

FIG. 7 is a user interface 700 allowing customization of verification checks. A dialog structure is indicated at 710 illustrating that a verification check file is being customized by an open folder icon. A particular decision basis model field is indicated at 715 along with an entity type at 720. Verification check boxes are indicated at 725, and include a not relevant checkbox at 730 and a no auto execution check box at 735 in one embodiment. Check box 730 sets a flag to define an entity type as not relevant for verification. Entities of this type will then be marked in the UI with verification mode “not relevant”. Check box 735 sets a flag to define an entity type that the rule should not be executed automatically. For example, the process stops here and has to be continued from the user interface.

A rule category is illustrated at 740. The rule category allows a user to define rules for the verification check.

In one embodiment, a completeness check is also provided. The completeness check help a caseworker to identify missing information regarding eligibility determination, entitlement determination or entitlement calculation for a given program administration. During the design time of a decision basis, a corresponding model defines which entities are mandatory and which are optional per usage. In one embodiment, there are three standard usages available, eligibility determination, entitlement determination, and entitlement calculation. A customer may define models specifying which data is mandatory or optional for each such usage.

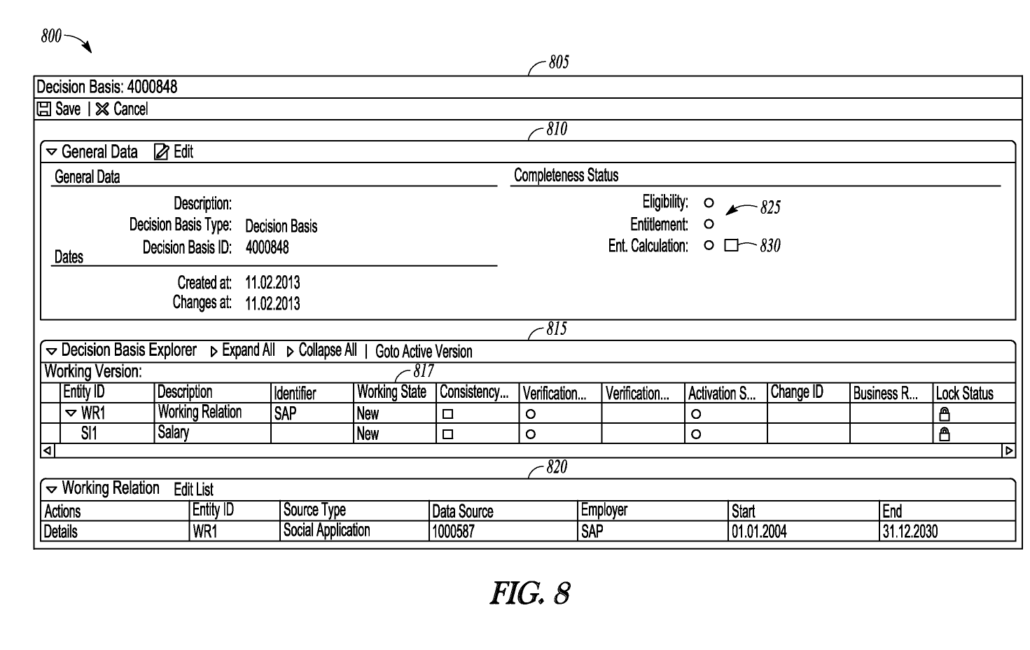

FIG. 8 is a user interface illustrating a decision basis 800. In one embodiment, each decision basis is given an ID 805, in this case “4000848”. There are three areas for each decision basis in one embodiment. General data is indicated at 810, a decision basis explorer is indicated at 815, and a details area is indicated at 820. General data provides a description of the decision basis, the ID, creation and change dates, and a completeness status for eligibility, entitlement and calculation as indicated at 825. Icons may be clickable for more details. The completeness status shows the caseworker if all “needed” information for the corresponding SSP process step is activated on the decision basis. In one embodiment, a traffic light looking icon 830, when clicked on, provides detailed information regarding “what to do” in order to obtain the data needed to ensure the data is complete.

The decision basis explorer portion 815 includes an entity ID, description, identifier, working state 817, consistency, verification files, activation, change ID, business relations and lock status to name a few example fields. The working state 817 is new for new and not active entities. Active entities get the status active. If an existing active entity is overwritten, the status gets changed to modified until it gets activated again.

The details area 820 displays the details of the entity which is selected in the decision basis explorer 815. If no line is selected, all assignment blocks for the tope entity types are displayed.

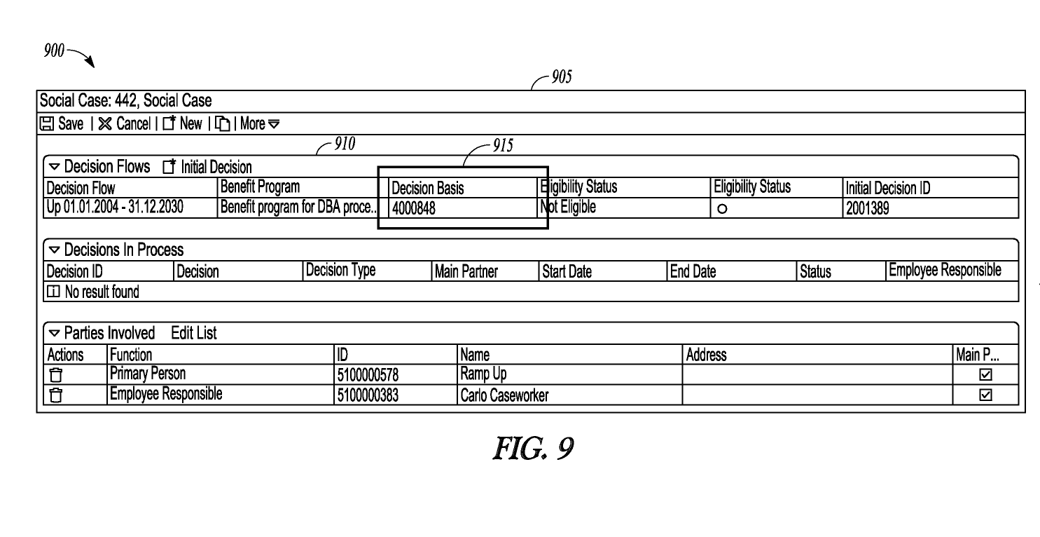

The decision basis may be navigated to from multiple different user interface screens while working on one or more cases. For example, FIG. 9 is a user interface 900 showing a view of a case currently being worked on. In this case, a social case number 442 is illustrated at 905. A particular decision flow 910 is illustrated for a benefit program for DBA processing. A link to the corresponding decision basis is indicated at 915, allowing a user to simply click on the link to view the decision basis for this selected case. Further status information is provided in interface 900, such as eligibility status and initial decision ID.

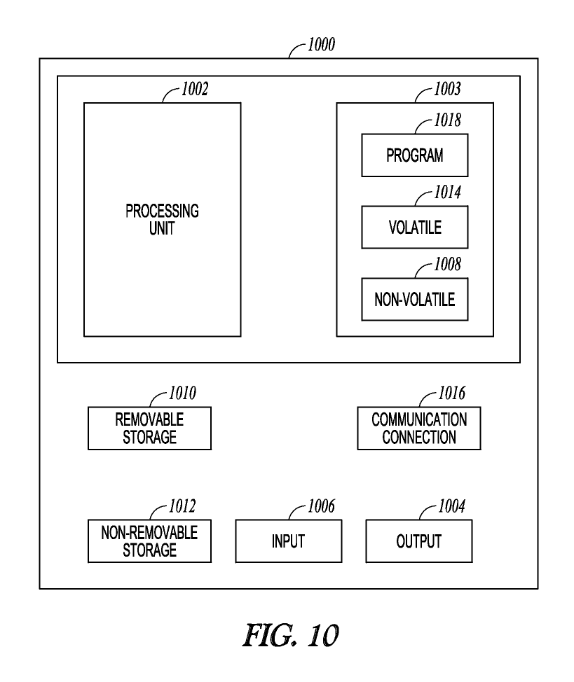

FIG. 10 is a block schematic diagram of a computer system 1000 to implement one or more methods and systems according to example embodiments. In one embodiment, multiple such computer systems, including laptop computers, desktop computers, smart phones, touchpads, and other devices are utilized in a distributed network to implement multiple components in a transaction based environment. An object-oriented, service-oriented, or other architecture may be used to implement such functions and communicate between the multiple systems and components. One example computing device in the form of a computer 1000, may include a processing unit 1002, memory 1003, removable storage 1010, and non-removable storage 1012. Memory 1003 may include volatile memory 1014 and non-volatile memory 1008. Computer 1000 may include—or have access to a computing environment that includes—a variety of computer-readable media, such as volatile memory 1014 and non-volatile memory 1008, removable storage 1010 and non-removable storage 1012. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 1000 may include or have access to a computing environment that includes input 1006, output 1004, and a communication connection 1016. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 1002 of the computer 1000. A hard drive, CD-ROM, and RAM are some examples of articles including a non-transitory computer-readable medium. For example, a computer program 1018 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 1000 to provide generic access controls in a COM based computer network system having multiple users and servers.

### EXAMPLES

1. A computer implemented method comprising:
populating a data structure, stored on a computer readable storage device, with data for use in determining eligibility for benefits from a benefits program, wherein the data structure comprises a hierarchical structure of entity types including top entity types and child entity types, wherein each child entity instance contains data related to a parent top entity type;
performing a verification check on entity instance data using evidence related to the entity instance data;
making a decision regarding eligibility for benefits based on the verified data in the data structure and rules for the benefits program; and
storing the data from the data structure utilized in the decision, including the evidence used in the verification check.

2. The method of example 1 and further comprising checking the data in the data structure for a minimum set of data specified for making the decision.

3. The method of any of examples 1-2 and further comprising performing a consistency check on the data in the data structure.

4. The method of example 3 and further comprising checking the data in the data structure for a minimum set of data specified by the benefits program for making the decision.

5. The method of any of examples 1-4 wherein the data used to populate the data structure is obtained from an application for benefits under the benefits program.

6. The method of example 5 wherein the evidence used to verify the entity instance data is obtained from an external source.

7. The method of any of examples 1-6 and further comprising providing an interface to a benefits administrator to facilitate changing the decision made by the computer.

8. The method of any of examples 1-7 wherein the verification check is performed on data from multiple entity instances identified by benefits program rules.

9. A computer readable storage device having instructions for causing a computer to execute a method, the method comprising:
populating a data structure, stored on a computer readable storage device, with data for use in determining eligibility for benefits from a benefits program;
performing a verification check on the data using evidence related to the data;
making a decision regarding eligibility for benefits based on the verified data and rules for the benefits program; and
storing the data utilized in the decision, including the evidence used in the verification check.

10. The computer readable storage device of example 9 wherein the method further comprises the data for a minimum set of data specified for making the decision.

11. The computer readable storage device of any of examples 9-10 wherein the method further comprises performing a consistency check on the data in the data structure.

12. The computer readable storage device of example 11 wherein the method further comprises checking the data in the data structure for a minimum set of data specified by the benefits program for making the decision.

13. The computer readable storage device of any of examples 9-12 wherein the data used to populate the data structure is obtained from an application for benefits under the benefits program.

14. The computer readable storage device of example 13 wherein the evidence used to verify the child entity instance data is obtained from an external source.

15. The computer readable storage device of example 14 wherein the evidence comprises salary information obtained from an employer of an applicant applying for benefits.

16. The computer readable storage device of any of examples 9-15 wherein the method further comprises providing an interface to a benefits administrator to facilitate changing the decision made by the computer.

17. The computer readable storage device of any of examples 9-16 wherein the verification check is performed on data from multiple child entity instances identified by benefits program rules.

18. A data structure stored on a computer readable storage device, the data structure comprising:
data for use in determining applicant eligibility for benefits from a benefits program, wherein the data is arranged in a hierarchical structure of entity types including top entity types and child entity types, wherein each child entity instance contains data related to a parent top entity type; and
verification data usable in verifying the data, wherein the data in the data structure comprises all data relied upon to determine eligibility and benefits under the benefits program.

19. The data structure of example 18 wherein the verification data comprises personal information of the applicant obtained from an external source.

20. The data structure of example 19 wherein the data comprises a minimum set of data specified by the benefits program for determining applicant eligibility. Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
populating a data structure, stored on a computer readable storage device, with data for use in determining eligibility for benefits from a benefits program, wherein the data structure comprises a hierarchical structure of entity types including top entity types and child entity types, wherein each child entity instance contains data related to a parent top entity type;
performing a verification check on entity instance data using evidence related to the entity instance data;
making a decision regarding eligibility for benefits based on the verified data in the data structure and rules for the benefits program; and
storing the data from the data structure utilized in the decision, including the evidence used in the verification check.

2. The method of claim 1 and further comprising checking the data in the data structure for a minimum set of data specified for making the decision.

3. The method of claim 1 and further comprising performing a consistency check on the data in the data structure.

4. The method of claim 3 and further comprising checking the data in the data structure for a minimum set of data specified by the benefits program for making the decision.

5. The method of claim 1 wherein the data used to populate the data structure is obtained from an application for benefits under the benefits program.

6. The method of claim 5 wherein the evidence used to verify the entity instance data is obtained from an external source.

7. The method of claim 1 and further comprising providing an interface to a benefits administrator to facilitate changing the decision made by the computer.

8. The method of claim 1 wherein the verification check is performed on data from multiple entity instances identified by benefits program rules.

9. A computer readable storage device having instructions for causing a computer to execute a method, the method comprising:
populating a data structure, stored on a computer readable storage device, with data for use in determining eligibility for benefits from a benefits program;
performing a verification check on the data using evidence related to the data;
making a decision regarding eligibility for benefits based on the verified data and rules for the benefits program; and
storing the data utilized in the decision, including the evidence used in the verification check.

10. The computer readable storage device of claim 9 wherein the method further comprises the data for a minimum set of data specified for making the decision.

11. The computer readable storage device of claim 9 wherein the method further comprises performing a consistency check on the data in the data structure.

12. The computer readable storage device of claim 11 wherein the method further comprises checking the data in the data structure for a minimum set of data specified by the benefits program for making the decision.

13. The computer readable storage device of claim 9 wherein the data used to populate the data structure is obtained from an application for benefits under the benefits program.

14. The computer readable storage device of claim 13 wherein the evidence used to verify the child entity instance data is obtained from an external source.

15. The computer readable storage device of claim 14 wherein the evidence comprises salary information obtained from an employer of an applicant applying for benefits.

16. The computer readable storage device of claim 9 wherein the method further comprises providing an interface to a benefits administrator to facilitate changing the decision made by the computer.

17. The computer readable storage device of claim 9 wherein the verification check is performed on data from multiple child entity instances identified by benefits program rules.

18. A data structure stored on a computer readable storage device, the data structure comprising:
data for use in determining applicant eligibility for benefits from a benefits program, wherein the data is arranged in a hierarchical structure of entity types including top entity types and child entity types, wherein each child entity instance contains data related to a parent top entity type; and
verification data usable in verifying the data, wherein the data in the data structure comprises all data relied upon to determine eligibility and benefits under the benefits program.

19. The data structure of claim 18 wherein the verification data comprises personal information of the applicant obtained from an external source.

20. The data structure of claim 19 wherein the data comprises a minimum set of data specified by the benefits program for determining applicant eligibility.
